(19) United States
(12) Patent Application Publication
(10) Pub. No.: US 2018/0200647 A1
(43) Pub. Date: Jul. 19, 2018

(54) SEPARATOR AND METHOD OF SEPARATION WITH AN AUTOMATED PRESSURE DIFFERENTIAL DEVICE

(71) Applicant: M-I L.L.C., Houston, TX (US)

(72) Inventor: David Josh Smith, Houston, TX (US)

(73) Assignee: M-I L.L.C., Houston, TX (US)

(21) Appl. No.: 15/852,970

(22) Filed: Dec. 22, 2017

Related U.S. Application Data
(60) Provisional application No. 62/437,820, filed on Dec. 22, 2016.

(51) Int. Cl. B01D 21/30; E21B 21/06; G01N 21/85; G01N 1/20; B01D 21/28

(52) U.S. Cl. CPC B01D 21/302; E21B 21/065; G01N 2021/8405; G01N 1/20; B01D 21/283; G01N 21/85

(57) ABSTRACT

Systems, separators and methods separate one or more solids from a fluid and utilize an automated pressure differential device to improve separation of the one or more solids and the fluid. The systems and methods comprise at least a pressure differential system adjacent a screen in a shaker for separating one or more solids from a fluid, the pressure differential system adapted to provide a pressure differential adjacent the screen in the shaker, a monitoring tool coupled to an actuated arm adjacent the shaker, the monitoring tool adapted to monitor the one or more solids and the fluid adjacent the screen in the shaker, and a controller in electrical communication with the pressure differential system, the monitoring tool and the actuated arm, wherein the controller adapted to control the pressure differential based on the monitoring of the one or more solids and the fluid adjacent the screen of the shaker.

### CROSS-REFERENCE TO RELATED APPLICATIONS

This application claims priority to U.S. Provisional Patent Application No. 60/437,820, filed Dec. 22, 2016, entitled “Separator and Method of Separation with an Automated Pressure Differential Device,” the disclosure of which is incorporated herein by reference in its entirety.

### BACKGROUND

Various industries, such as oil and gas, mining, agriculture and the like utilize equipment and/or methods for separating fluids from materials. For example, in the mining industry, the separation of a desired mineral component from the undesirable gangue of an ore is a necessary and significant aspect of mining. Tailings are the materials left over after the process of separating the valuable ore from the gangue. Mine tailings are usually produced from a mill in slurry form that is typically a mixture of fine mineral particles and water.

Another example of such a separation method is found in the oil and gas industry. For example, oilfield drilling fluid, often called “mud,” serves multiple purposes in the oil and gas industry. Among its many functions, the drilling mud acts as a lubricant for a drilling bit and increases rate of penetration of the drilling bit. The mud is pumped through a bore of the drill string to the drill bit where the mud exits through various nozzles and ports, lubricating the drill bit. After exiting through the nozzles, the “spent” fluid returns to the surface through an annulus formed between the drill string and the drilled wellbore. The returned drilling mud is processed for continued use.

Another significant purpose of the drilling mud is to carry the cuttings away from the drill bit to the surface. The drilling fluid exiting the borehole from the annulus is a slurry of formation cuttings in drilling mud, and the cuttings must be removed before the mud is reused.

One type of apparatus used to remove cuttings and other solid particulates from drilling mud is commonly referred to in the industry as a “shaker” or “shale shaker.” The shaker, also known as a vibratory separator, is a vibrating sieve-like table upon which returning used drilling mud is deposited and through which substantially cleaner drilling mud emerges. Typically, the shaker is an angled table with a generally perforated filter screen bottom. Returning drilling mud is deposited at the top of the shaker. As the slurry moves toward a discharge end that may be higher than an inlet end, the fluid falls through the perforations to a reservoir below thereby leaving the solid particulate material and/or cuttings behind. The combination of the angle of inclination with the vibrating action of the shaker table enables the solid particles left behind to flow until they fall off the lower end of the shaker table. The above described apparatus is illustrative of an exemplary shaker known to those of ordinary skill in the art.

Screens used with shakers are typically placed in a generally horizontal fashion on a generally horizontal support within a basket or tray in the shaker. The shaker imparts a rapidly reciprocating motion to the basket and hence the screens. Material from which particles are to be separated is poured onto a back end of the vibrating screen and may be conveyed along the shaker toward the discharge end of the shaker or basket of the shaker.

In some shakers, a fine screen cloth is used with the vibrating screen. The screen may have two or more overlaying layers of screen cloth and/or mesh. Layers of cloth and/or mesh may be bonded together and placed over a support. The frame of the vibrating screen is suspended and/or mounted on a support and vibrates by a vibrating mechanism to create a flow of trapped solids on top surfaces of the screen for removal and disposal of solids.

### BRIEF DESCRIPTION OF THE DRAWINGS

The foregoing and other features of the present disclosure will become more fully apparent from the following description and appended claims, taken in conjunction with the accompanying drawings. Understanding that these drawings depict several embodiments in accordance with the disclosure and are, therefore, not to be considered limiting of its scope, the disclosure will be described with additional specificity and detail through use of the accompanying drawings.

FIG. 1 is a perspective view of a vibratory separator or shaker (hereinafter “shaker”) having screens usable with an automated pressure differential system in accordance with embodiments disclosed herein.

FIG. 2 is a side view of an automated pressure differential system in accordance with embodiments disclosed herein.

FIG. 3 is a schematic representation of a pressure differential monitoring system having shakers usable with automated pressure differential systems in accordance with embodiments disclosed herein.

FIG. 4 is a perspective view of another pressure differential monitoring system in accordance with embodiments disclosed herein.

FIG. 5 is a perspective view of another pressure differential monitoring system monitoring an automated pressure differential system of a shaker in accordance with embodiments disclosed herein.

FIG. 6 is a schematic representation of a monitoring and control system arranged in accordance with at least an embodiment of the present disclosure.

### DETAILED DESCRIPTION

In the following detailed description, reference is made to the accompanying drawings, which form a part hereof. In the drawings, similar symbols and/or reference numbers identify similar components, unless context dictates otherwise. The illustrative embodiments described in the detailed description and drawings are not meant to be limiting and are for explanatory purposes. Other embodiments may be utilized, and other changes may be made, without departing from the spirit or scope of the subject matter presented herein. It will be readily understood that the aspects of the present disclosure, as generally described herein, and illustrated in the drawings, may be arranged, substituted, combined, and designed in a wide variety of different configurations, each of which are explicitly contemplated and made part of this disclosure.

This disclosure is generally drawn to systems, devices, apparatuses, and/or methods related to monitoring and/or controlling automated pressure differential system of a shaker used for separating solids or cuttings from fluid. Specifically, the presently disclosed systems, devices, apparatuses, and/or methods relate to monitoring, controlling and/or changing one or more characteristics and/or parameters of at least one pressure differential provided by the pressure differential system. As a result, the presently disclosed systems, devices, apparatuses and/or methods may maximize fluid recovery while minimizing fines passing through one or more screens of the shaker and/or reducing damage to the one or more screens of the shaker.

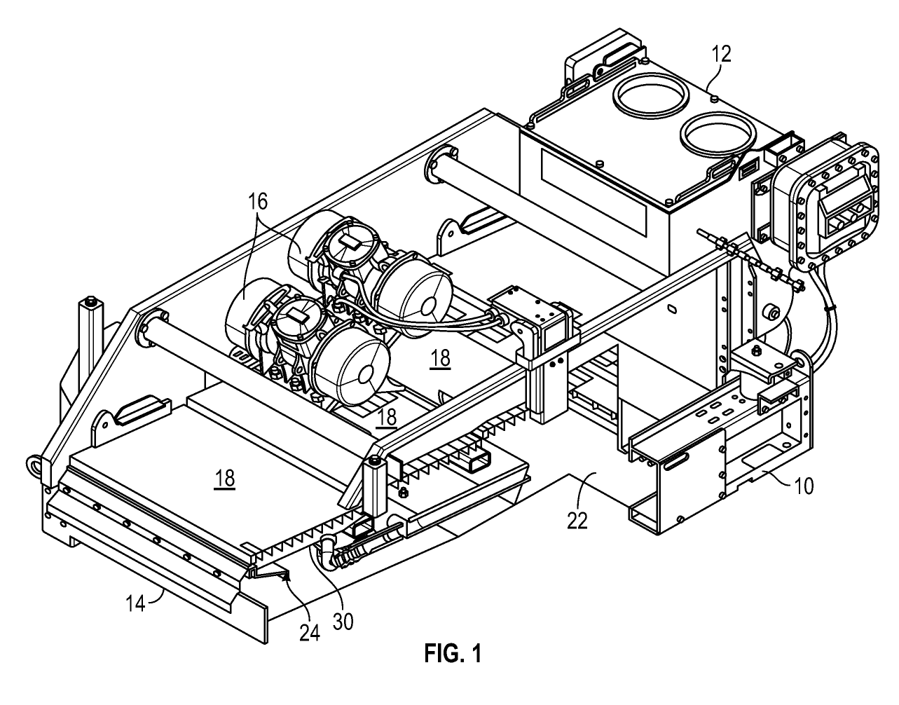

Referring now to FIG. 1, a separator 10, such as a vibratory or fluid and cuttings separator and/or shale shaker (hereinafter collectively referred to as “shaker 10”) in accordance with embodiments disclosed herein is illustrated. The shaker 10 may have an inlet or feed end 12 (hereinafter “inlet end 12”) and an outlet or discharge end 14 (hereinafter “discharge end 14”) located opposite with respect to the inlet end 12. A slurry may be provided to the shaker 10 at the inlet end 12 of the shaker 10. The slurry, as used herein, can include hydrocarbons, drilling fluid, weighting agents, water, lost circulation material, drill cuttings and/or other fluids or substances present in the wellbore, such as, for example, the formation cuttings, gas, or oil. The slurry may have two or more portions that may be separated.

The shaker 10 may have motors 16 to generate and/or impart vibrational motion, for example linear, elliptical, or progressive elliptical, to the shaker 10, and one or more screens 18 (hereinafter “screens 18”) of the shaker 10 for separating the components of the slurry. The screens 18 may have a mesh stretched or tensioned on a metal, composite and/or other frame material. The slurry may be fed to the inlet end 12 of the shaker 10 and onto the screens 18. The slurry may be conveyed within the shaker 10 toward the discharge end 14 and/or across the screens 18. The vibratory motion imparted by the motors 16 and/or the screens 18 may aid in separating the slurry. For example, a first portion of the slurry, such as, for example, liquid and/or solids below a predetermined size, can be sized to pass through openings or apertures in the screens 18 of the shaker 10. A second portion of the slurry can be sized to be conveyed to the discharge end 14 of the shaker 10 and may include solids, such as, for example, rock or formation cuttings (hereinafter “cuttings”). It will be appreciated by those having ordinary skill in the art that in the case of liquid/solid separation that a portion of the liquid may remain on the solids being discharged from the shaker 10.

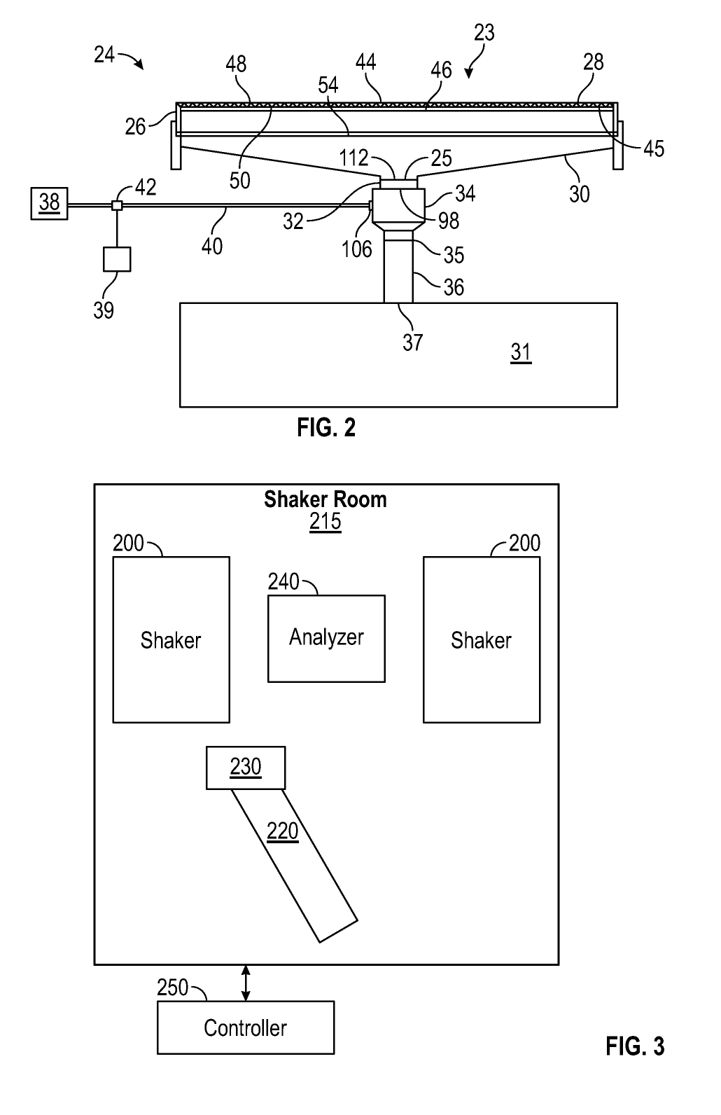

FIG. 2 illustrates an embodiment of a pressure differential system 24 (hereinafter “PDS 24”) that may be secured to or connected to a vibratory or fluid and cuttings separator, such as the shaker 10, as shown in FIG. 1. For example, the PDS 24 may be secured, connected and/or attached to a vibrating basket 26 of the separator 10. The PDS 24 may be secured or otherwise connected to the separator 10 at one or more of the screens 18, all of the screens 18, and/or a portion of one or more of the screens 18 of the shaker 10. In an embodiment, the PDS 24 may connected, attached or secured to at least one screen 18 adjacent to the discharge end 14 of the shaker 10.

In embodiments, the PDS 24 may be attached to, connected to, sealed to or otherwise positioned under a screen 28 of the shaker 10, as shown in FIG. 2, which may be adjacent to the discharge end 14 of the shaker 10. In an embodiment, the screen 28 may be one of the screens 18, shown in FIG. 1. The screen 28 may have a mesh 44 stretched or pre-tensioned across a frame 46. The mesh 44 may have a top surface 48 and a bottom surface 50. The mesh 44 may be a single layer of woven mesh wire or may be multiple layers of woven mesh wire. In an embodiment, the mesh 44 may have apertures of one or more predetermined sizes.

For example, the size or sizes of the apertures may be selected to separate the first portion of the slurry from the second portion of the slurry, such as, for example, at least a portion of the wellbore fluid from the cuttings. Mesh size or sizes, as used herein, refers to the size or sizes of the apertures in the mesh 44. The first portion of the slurry, such as, for example, at least a portion of the wellbore fluid and solids smaller than the size or sizes of the apertures of the mesh 44, may fall or move through the mesh 44 into a bottom or sump 22 (hereinafter “sump 22”) of the shaker 10, shown in FIG. 1. The second portion, such as, for example, the cuttings larger than the apertures of the mesh 44, may be conveyed to the discharge end 14 of the shaker 10 across screen 28 and/or screens 18. In an embodiment, the first portion of the slurry can pass through the screen 28, and the first portion may be, for example, the wellbore fluid and weighting agents or other solids smaller than the apertures in the screen 28. The first portion can be collected in the sump 22 located at the lower part or in the bottom of the shaker 10. The second portion of the slurry, for example, may include solids or cuttings with a size larger than a size or sizes of the apertures of the mesh 44 and wellbore fluid not separated from the cuttings. The cuttings separated from the wellbore fluid, for example, the first portion can be conveyed to the discharge end 14 of the shaker 10, as shown in FIG. 1.

The PDS 24 may comprise a tray 30, a connection conduit 32, a pressure differential generating device 34 and/or an output conduit 36, as shown in FIG. 2. The PDS 24 may generate at least one pressure differential with respect to a top area 23 above the screen 28 and a bottom area 25 below the screen 28. The pressure differential generating device 34 may be connected to a fluid source 38 through a conduit 40. The fluid source 38 may provide fluid, such as liquid or gas, for example, air, compressed air, nitrogen, carbon dioxide, wellbore fluid, drilling fluid or other fluids usable in the pressure differential generating device 34 to generate the at least one pressure differential. The flow of fluid from the fluid source 38 to and/or through the pressure differential generating device 34 may cause the at least one pressure differential across the screen 28. It should be noted that the movement of the fluid from the fluid source 38 through the pressure differential generating device 34 may provide motive force for air above the screen 28 to move into and through the pressure differential generating device 34. The motive force of the air moving through the pressure differential generating device 34 may cause or may increase the pressure differential.

The at least one pressure differential may increase separation of the slurry, such as additional fluid being removed from the cuttings that would otherwise be removed without the at least one pressure differential. The pressure differential with respect to the top area 23 and the bottom area 25 of the screen 28 causes additional fluid from the slurry to pass through the screen 28 and/or into the sump 22 as compared to the amount that would pass through without the pressure differential. Where the slurry is comprised of wellbore fluid and cuttings, the additional wellbore fluid recovered may result in a lesser amount or lesser volume of drill fluid being used, since, for example, the additional drilling fluid recovered may be processed and re-used. In addition, the additional wellbore fluid recovered can result in the cuttings on the discharge end 14 of the shaker 10 being dryer, that is having less of the wellbore fluid contained on or within the cuttings. As a result, a total volume or amount of the wellbore fluid and the cuttings discharged from the discharge end 14 of the shaker 10 may be reduced. Additionally, if oil based drilling fluid is within the slurry, the reduction of oil on cuttings can be significant from a disposal or further processing perspective.

A fluid control assembly 42 may be connected to the conduit 40 between the fluid source 38 and the pressure differential generating device 34. The fluid control assembly 42 may have logic and/or devices to actuate a device 39 to change or alter an amount of fluid provided to the pressure differential generating device 34. For example, the device 39 may fully open, partially open, fully close or partially close fluid communication between the fluid source 38 and the pressure differential generating device 34.

In an embodiment shown by FIG. 2, the pressure differential system 24 may be connected to a container 31 through the output conduit 36. The container 31 may be the bottom or sump 22 of the shaker 10 shown in FIG. 1 or may be a container external to the shaker 10, such as a holding tank, where the gas or air may be vented, separated or re-used as the fluid for the fluid source 28. The output conduit 36 may be flexible and have a first end 35 secured to the pressure differential generating device 34. A second end 37 of the output conduit 36 may be connected to the container 31.

In an embodiment, the PDS 24 may comprise a pan, tray or device on a shaker bed underneath the screen 28 of the shaker 10 or the shakers 210, and may be adjacent to the discharge end 14 of the shaker 10. The pressure differential generating device 24 may comprise a device generating a pressure differential according to the Venturi principle, such as an air amplifier. A fluid source 38, the device 39 and the fluid control assembly 42, may be in fluid communication to provide fluid to the pressure differential generating device 24 to pull or separate residual drilling fluid from surfaces of the cuttings as the slurry travels towards the discharge end 14 of the shaker 10 or the shakers 210 above the pan and over screen 28. The fluid may be a supplied from a compressor and/or may utilize rig air to provide the fluid to the PDS 24.

In embodiments, the PDS 24 and/or the pressure differential generated device 34 may frequently or non-frequently provide one or more pressure differentials at or near the bottom side of the screen 28 as the slurry may continuously move on or along the screen 28 towards the discharge end 14 to increase separation of the slurry at the screen 28 and/or may be leaving the discharge end of the shaker 10. The intensity, frequency and/or duration of these pressure differentials provided by the PDS 24 and/or the pressure differential generated device 34 as the slurry moves on or along the screen 28 towards and/or leaving the discharge end 14 may be the same, substantially the same, different or substantially different.

Changing the application of these pressure differentials may be advantageous to improve operational parameters associated with the shaker 10 and/or the screen 28 or screens 18. These operational parameters may include, but are not limited to, maximizing fluid recovery, minimizing the fines passing through the screen 28 and/or reducing damage to the screen 28 and/or the screens 18 of the shaker 10. The frequency, duration and/or intensity of each pressure differential provided at or near the bottom side of the screen 28 may be controlled, changed and/or manipulated by the presently disclosed systems, devices, apparatuses, and/or methods to improve one or more of the parameters. After monitoring and/or analyzing discharged components of the shaker 10 at, near, adjacent and/or below the discharge end 14, the screen 28, the screens 18 and/or PDS 24, the present systems, devices, apparatuses, and/or methods disclosed herein may automatically control, adjust and/or change the frequency, intensity and/or duration of at least one subsequently provided pressure differential to improve one or more of the operational parameters associated with the shaker 10 and/or the screen 28 or screens 18. As a result, the present systems, devices, apparatuses, and/or methods disclosed herein may achieve at least one selected from enhanced shale shaker performance and improved ultra-fine screen separation efficiency for the shaker 10 by automatically controlling the PDS 24 to adjust and/or change the pressure differential provided by the PDS 24. For example, the pressure differential amount may change from a first predetermined amount to a second predetermined amount on regular intervals. For example, the first predetermined value may be an amount to pull air through the screen 28 and/or additional fluid through the screen 28. In an embodiment, the first predetermined value may stall the slurry on the screen. However, the first predetermined value may pull additional fluid and/or air through the screen 28 without stalling the slurry. The second predetermined value can be less than the first predetermined value, such as an amount to permit the slurry to pass along the screen 28. In an embodiment, the second predetermined value is zero. In other embodiments, the first predetermined value may create a high pressure differential and the second predetermine value may create a lower pressure differential. The device 39 may control the amount of time the first predetermined value is provided to the screen 28 as opposed to the second predetermined value.

FIG. 3 is a schematic view of a pressure differential monitoring system 200 (hereinafter “system 200”) including shakers 210 positioned or located within a shaker room 215 and at least one monitoring tool 230 (hereinafter “monitoring tool 230”) for monitoring the shakers 210 and/or the shaker room 215, arranged in accordance with embodiments of the present disclosure. In embodiments, the monitoring tool 230 may monitor characteristics of the slurry within the shakers 210, the slurry at, near and/or adjacent to the discharge end 14 of the shakers 210, the slurry and/or cuttings exiting or leaving the discharge end 14 and/or separated fluid passing through one or more screens of the shakers 210, such as, for example, the screens 18 or the screen 28 shown in FIG. 1 or 2, respectively.

In embodiments, the system 200 may comprise one or more selected from the shakers 210, the monitoring tool 230 coupled to an actuated arm 220, an analyzer 240, and a controller 250. The controller 250 may be connected to and/or in digital and/or electrical communication with the shakers 210, the PDS 24 of each shaker 210, the actuated arm 220, the monitoring tool 230 and/or the analyzer 240. As a result, the controller 250 may be capable of controlling and/or adjusting activities, functions and/or operations of the shakers 210, the PDS 24 of each shaker 210, the actuated arm 220, the monitoring tool 230 and/or the analyzer 240.

In embodiments, the controller 250 may send one or more digital or electronic control signals to the shaker room 215 (and/or directly to the shakers) for controlling and/or adjusting activities, functions and/or operations of the shakers 210, the PDS 24 of each shaker 210, the actuated arm 220, the monitoring tool 230 and/or the analyzer 240 located therein. As a result of receiving the one or more digital or electronic control signals, one or more activities, functions and/or operations performed and/or executed by the shakers 210, the PDS 24 of each shaker 210, the actuated arm 220, the monitoring tool 230 and/or the analyzer 240 may be controlled by the controller 250. In an embodiment, the one or more digital or electronic control signals received by the PDS 24 control and/or fluid control assembly 42 may adjust and/or change one or more of the operational parameters of the PDS 24. As a result of receiving the one or more digital or electronic control signals, the PDS 24 may increase or decrease one or more subsequent pressure differentials applied to the slurry and/or cutting by the PDS 24.

The monitoring tool 230 may monitor the activities, operations and/or performances of, or associated with, the shakers 210 in the shaker room 215. As a result, the monitoring tool 230 may monitor a status, quality and/or property of, or associated with, the slurry, fluids and/or solids or cuttings being separated in the shakers 210, a status, a quality and/or property of, or associated with, slurry at or near, for example, the discharge end 14 and/or screen 28 of the shakers 210, a status, quality and/or property of, or associated with, the cuttings leaving the discharge end 14 and/or a status or quality of, or associated with, the separated fluid passing through, for example, the screen 28 of the shakers 210.

The analyzer 240 may analyze a property of the slurry, fluid and/or solids or cuttings based on the monitored status, quality and/or property and/or based on the monitoring executed by the monitoring tool 230. The controller 250 may control the actuated arm 220 and/or may control, adjust and/or change one or more operational parameters of the PDS 24 of each shaker 210 based, at least in part, on the monitored status or quality, the monitoring executed the monitoring tool 230 and/or the property analyzed by the analyzer 240. In embodiments, the one or more operational parameters of the PDS 24 may be one or more operational parameters associated with the pressure differential generating device 34, the fluid source 38, the device 39 and/or the fluid control assembly 42 of the PDS 24. By controlling, adjusting and/or changing the one or more operational parameters of the PDS 24, the controller 250 may control, adjust and/or change the amount, the frequency, the duration and/or the intensity of one or more subsequent pressure differentials applied or provided by the PDS 24. In other words, the controller 250 may automatically increase the pressure differential to pull or separate more fluid from the cuttings or decrease the pressure differential to pull or separate less fluid from the cutting and to prevent blinding on or of the screens of the shakers 210.

In embodiments, the monitoring tool 230 and/or the analyzer 240 may analyze and/or determine an amount of fluids present on the cuttings leaving the discharge end 14 or on the cuttings on the screen 28 adjacent to the discharge end 14. Based on the analyzed and/or determined amount of fluids, the controller 250 may increase or decrease one or more subsequent pressure differentials applied to the slurry and/or cutting provided by the PDS 24 of each shaker 210. Moreover, the monitoring tool 230 and/or the analyzer 240 may analyze and/or determine an amount of fines present in the separated fluids passing through, for example, the screen 28. Based on the analyzed and/or determined amount of fines, the controller 250 may increase or decrease one or more subsequent pressure differentials applied to the slurry and/or cutting provided by the PDS 24 of each shaker 210 and/or may make a change or adjustment with respect to one or more screens of the shakers 210. The change or adjustment with respect to the one or more screens of the shakers 210 may include replacing or repositioning one or more of the screens of the shakers 210 which may be executed by the actuated arm 220 and/or controlled by the controller 250. Furthermore, the change or adjustment of the one or more screens may include exchanging the one or more screens with at least one screen having larger or smaller apertures to increase or decrease the amount of fines present in the separated fluids.

The actuated arm 220 may be controllable via the controller 250 and capable of sensing the status, quality and/or conditions at, on or near the screens located at, adjacent to or near the discharge ends 14 of the shakers 210, sampling the slurry, fluids and/or solids or cutting being processed and separated by the shakers 210 and/or analyzing or determining the status, quality, property and/or conditions of the slurry, fluids and/or solids or cuttings being processed and separated by the shakers 210. In an embodiment, the actuated arm 220 may include one or more sensors to measure a position and/or orientation of the actuated arm 220 and/or one or more sensors to measure, analyze and/or determine the status, quality and/or property of the slurry, fluids and/or solids or cuttings being processed and separated by the shakers 210. Example sensors may include any sensor known in the art. In embodiments, a sensor may be able to communicate the position of the actuated arm 220 and the controller 250 may be able to send signals to control an actuator, thereby enabling the actuator to move the actuated arm 220 to a desired position or orientation to effectuate an action, such as, for example, taking or collecting a sample of the slurry, fluids and/or solids or cutting being processed and separated by the shakers 210. In an embodiment, the sensor may be an imaging sensor for determining an amount of fluid on the cuttings or remaining in the slurry near or adjacent to the discharge end 14 and/or an amount of fines present in the separated fluid passing through the screens of the shakers 210. Those having ordinary skill in the art will appreciate that other arrangements for an actuator to move an actuated arm 220 or a component thereof in accordance with examples disclosed herein may be used without departing from the scope of the present disclosure.

In embodiments, the monitoring tool 230 may include a camera, a video camera, an imaging device, and/or an imaging sensor (hereinafter “imaging device”). The imaging device may produce, record or store an image and/or video of the shaker room 215, the shakers 210 and/or the slurry, fluids and/or solids or cutting being processed and separated by the shakers 210 adjacent to or near the discharge end 14. The imaging device may transmit the produced, recorded or stored image and/or video to the controller 250. In response to receiving and/or analyzing the image and/or video produced by the imaging device, the controller 250 may automatically control, adjust or change the one or more operational parameters of the PDS 24 and/or may automatically control the actuated arm 220, or a tray associated or connected to the actuated arm 220, to take or collect a sample of the slurry, fluids and/or solids or cutting being processed and separated by the shakers 210. Thus, the controller 250 may automatically increase or decrease one or more subsequent pressure differentials provided by the PDS 24 based on the received and analyzed image produced by the imaging device.

In embodiments, the imaging device of the monitoring tool 230 may be operative to identify the status, quality or property of the slurry, fluids and/or solids or cuttings being processed and separated by the shakers 210 adjacent to or near the discharge end 14 of the shakers 210. After an image or video produced by the imaging device is analyzed, the controller 250 may identify and/or determine the status, quality and/or property of the slurry, fluids and/or solids being processed and separated by the shakers 210. Based, at least in part, on the identified and/or determined status, quality and/or property, the controller 250 may automatically control, adjust and change the one or more operational parameters of the PDS 24 to automatically increase or decrease an amount of at least one subsequent pressure differential provided or applied by the PSD 24.

For example, the controller 250 may determine an amount of fluid on the cuttings and/or fines in the separated fluid based, at least in part, on the received and analyzed image and/or video produced by the imaging device of the monitoring tool 230. Based on the determined amount of fluid on the cuttings and/or fines in the separated fluid, the controller 250 may automatically control, adjust and/or change the operational parameters of the PDS 24 to automatically increase or decrease an amount of one or more subsequent pressure differentials provided or applied by the PDS 24.

The controller 250 may automatically control the actuated arm 220 or the tray to take or collect a sample of the slurry, fluids and/or solids or cuttings being processed and separated by the shakers 210. In embodiments, the sample may be taken or collected from a position or location adjacent to or near the discharge end 14 and/or above or below the screen 28 and/or the screens 18. In an embodiment, the controller 250 may determine or select the position or location for taking or collecting the sample based, at least in part, on the identified or determined status, quality and/or property of the slurry, fluids and/or solids or cutting being processed and separated by the shakers 210. In an example, the actuated arm 220 may take or collect the sample from the slurry and/or cutting at a position or location on the screen adjacent to the discharge end 14 of the shakers 210. In another example, the actuated arm 220 may take or collect the sample from the slurry and/or cutting at a position or location where the slurry and/or cuttings is exiting or leaving the discharge end 14. In yet another example, the actuated arm may take or collect the sample from the separated fluids passing through one screen of the shakers 210 at a position or location below the screen 28 or the screens 18.

In an embodiment, the actuated arm 220 may deliver the collected sample directly to the analyzer 240 for analysis of the collected sample. Upon analysis of the collected sample by the analyzer 240, the controller 250 and/or the analyzer 240 may identify or determine the status, quality and/or property of the collected sample containing the slurry, fluids and/or solids, fines or cuttings being processed and separated by the shakers 210. Based, at least in part, on the identified or determined status, quality and/or property, the controller 250 may automatically control, adjust and change the one or more operational parameters of the PDS 24 of the shakers 210. Thus, the controller 250 may automatically increase or decrease an amount of at least one subsequent pressure differential provided by the PDS 24 based, at least in part, on the identified or determined status, quality and/or property of the collected sample.

In an embodiment, the collected sample may be further processed or separated before the imaging device of the monitoring tool 230 produces an image or video of the content(s) of the collected sample. For example, the content(s) of the collected sample may be allowed to settle for a duration of time before the imaging device produces the image or video of the content(s) of the collected sample. After analyzing the image or video of the content(s), the controller 250 may identify or determine the status, quality and/or property of the content(s) of the collected sample which may comprise the slurry, fluids and/or solids, fines or cuttings being processed and separated by the shakers 210. The controller 250 may identify or determine the status, quality and/or property of the content(s) of the collected sample by comparing the produced image or video of the content(s) of the collected sample to one or more known or comparative pictures, images or videos that have known or substantially known or comparative status, quality and/or property. For example, the one or more known or comparative pictures, images or videos may comprise known or comparative amounts of fluid on cuttings or known or comparative amount of fines in separated fluids passed through the screen 28 or the screens 18 having the same or substantially the same aperture size or sizes. As a result of this comparison, the controller 250 may identify or determine a first determination or measurement of the status, quality and/or property of the content(s) of the collected sample. Based, at least in part, on the identified or determined first measurement, the controller 250 may automatically control, adjust and change the one or more operational parameters of the PDS 24 of the shakers 210. Thus, the controller 250 may automatically increase or decrease an amount of one or more subsequent pressure differentials based, at least in part, on the identified or determined first determination or measurement associated with the content(s) of the collected sample.

In an embodiment, a second determination or measurement of the status, quality and/or property of the content(s) that is more accurate than the first determination or measurement may be necessary and/or required before the controller 250 may efficiently and/or accurately control, adjust and change the one or more operational parameters of the PDS 24. To obtain or determine this second determination or measurement, the controller may control the actuated arm 220 to deliver the collected sample to the analyzer 240 for further analysis of the content(s) of the collected sample. Upon further analysis of the content(s) of the sample conducted or completed by the analyzer 240, the controller 250 and/or the analyzer 240 may identify or determine the second determination or measurement of the status, quality and/or property of the content(s) of the collected sample. Based, at least in part, on the identified or determined second measurement, the controller 250 may automatically control, adjust and change the one or more operational parameters of the PDS 24. Thus, the controller 250 may automatically increase or decrease an amount of one or more subsequent pressure differentials based, at least in part, on the identified or determined second measurement associated with the content(s) of the collected sample.

In an embodiment, one or more selected from the actuated arm 220, the monitoring tool 230, the analyzer 240 and the controller 250 may be connected, attached and/or coupled to one another to form or provide an electromechanical machine. The formed or provided electromechanical machine may be guidable by a computer program and/or electronic circuitry to control activities and/or operations of at least one selected from the shaker 10, the motors 16, the PDS 24, the shakers 210, the actuated arm 220, the monitoring tool 230 and the analyzer 240. In an embodiment, the electromechanical machine may be autonomous or semi-autonomous machine and/or an industrial robot or robot system.

In embodiments, the monitoring tool 230 may determine a quantity and one or more characteristics or properties of the solids being separated from the fluid by the shaker 210. The one or more characteristics or properties may include, for example, texture, color, and size of the solids. The controller 250 may automatically cause the actuated arm 220 to adjust or replace the screen of the shaker 210 based on the determined characteristics of the solids or may automatically control, adjust or change one or more of the operational parameters of the PDS 24 based, at least in part, on the determined characteristics of the solids.

In an embodiment, the status, quality and/or property of the slurry, fluids and/or solids or cuttings determined by analyzer 240 may comprise one or more properties of fluid and/or solids which may include one or more selected from a chemical property, a mineralogical property and a physical property, such as, for example, density, temperature, flow rate, hardness, viscosity, mass, an amount of fluid on the cuttings and an amount of fins in the separated fluid.

In some embodiments, the monitoring tool 230 and the analyzer 240 may be integrated in a single component or device that may be coupled to the actuated arm 220.

In some examples, a collection tool or tray for collecting the sample may be coupled to the actuated arm 220. The collection tool or tray may be controlled by the controller 250 to collect the sample which may comprise a portion of the slurry, fluids and/or solids, fines or cuttings being processed and separated by the shakers 210. A time stamp of the day and time the sample was collected may be recorded to identify the collected sample. A rinsing tool coupled to the actuated arm 220 may be controlled by the controller 250 to rinse the collected sample with a fluid after collection of the collected sample. For example, the actuated arm 220 may include a nozzle disposed thereon to emit a cleaning fluid therefrom, such as water or another cleaning fluid.

In some examples, an x-ray fluorescence device may be provided. The x-ray fluorescence device may determine an amount of low gravity solids and an amount of high gravity solids in the fluid. The x-ray fluorescence device may analyze the fluid entering the shakers 210 and the fluid exiting the shakers 210, and compare the amount of the low gravity solids and the high gravity solids in the fluid entering the shakers 210 with the amount of the low gravity solids and the high gravity solids in the fluid exiting the shakers 210. Based on this comparison, the controller 250 may adjust or replace one or more screens of the shakers 210 and/or may automatically control one or more operational parameters of PDS 24 to automatically increase or decrease an amount of one or more subsequent pressure differentials provided by the PDS 24.

In embodiments, the controller 250 may be a computerized controller with or without a human operator. In an embodiment, the controller 250 may be located remotely from the shakers 210 and/or the shaker room 215. In another embodiment, the controller 250 may directly and/or indirectly control other equipment or processes to process the fluid before, during, or after the fluid enters the shakers 210 and/or the shaker room 215.

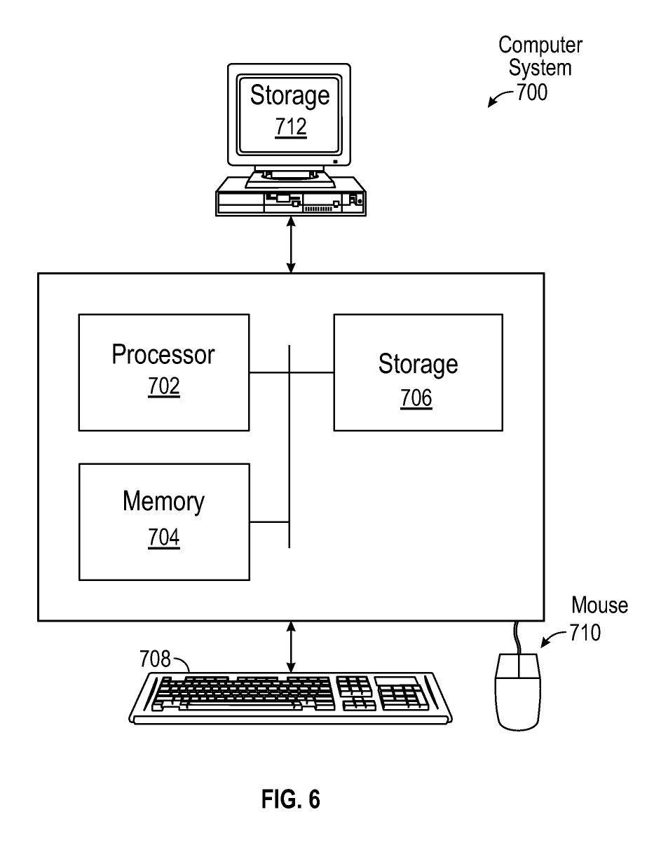

One or more examples of the present disclosure may be implemented on any type of computer system. In embodiments, the controller 250 may be a computer system, such as, for example, computer system 700 which may include a processor 702, associated memory 704, storage device 706, and numerous other elements and functionalities typical of known computers as shown in FIG. 6. The memory 704 may include computer or software instructions for causing the computer system 700 to observe and/or control activities and/or operations one or more selected from the actuated arm 220, the shaker 10, the shakers 210, at least one PDS 24 and one or more drilling operations in accordance with some embodiments of the present disclosure. Moreover, the memory 704 may include computer or software instructions for automatically controlling, changing and/or adjusting one or more operational parameters of the at least PDS 24 based, at least in part, on the analyzed and/or determined status, quality and/or property of the slurry, fluids and/or solids, fines or cutting being processed and separated by the shaker 10 or shakers 210. Thus, the controller 250 and/or the computer system 700 may automatically increase or decrease an amount of one or more subsequent pressure differentials provided by the PDS 24 based, at least in part, on the analyzed and/or determined status, quality and/or property. For example, the controller 250 and/or the computer system 700 may automatically increase or decrease an amount of one or more subsequent pressure differentials provided by the PDS 24 based, at least in part, on the analyzed and/or determined amount of fluid on the cuttings and/or fines in the separated fluids passing through the screen 28 of the shaker 10 or the shakers 210.

The computer system 700 may also include input means, such as a keyboard 708 and a mouse 710, and output means, such as a monitor 712. The computer system 700 may be connected to a local area network (LAN) or a wide area network (e.g., the Internet) via a network interface connection. Those skilled in the art will appreciate that these input and output means may take other forms, now known or later developed.

Further, those skilled in the art will appreciate that one or more elements of the computer system 700 may be located at a remote location and coupled to the other elements over a network. Some embodiments may be implemented on a distributed system having a plurality of nodes, where portions of the present disclosure may be located on a different node within the distributed system. In some embodiments, the node may correspond to a computer system. Alternatively, the node may correspond to a processor with associated physical memory. The node may alternatively correspond to a processor with shared memory and/or resources. Further, computer or software instructions to perform some embodiments of the present disclosure may be stored on a tangible computer readable medium such as a digital video disc (DVD), compact disc (CD), a diskette, a tape, or any other suitable tangible computer-readable storage device.

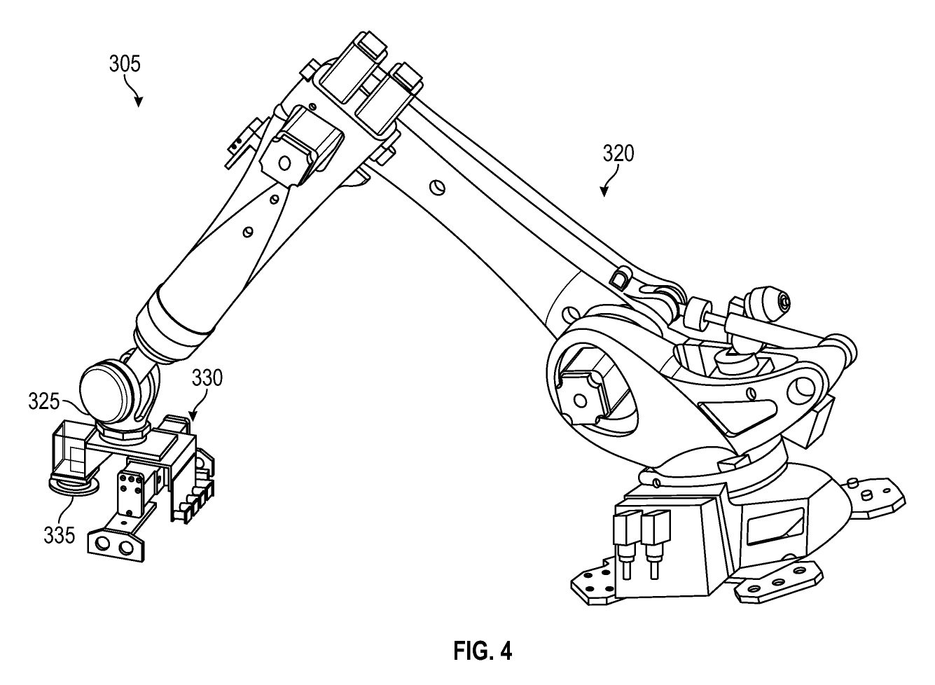

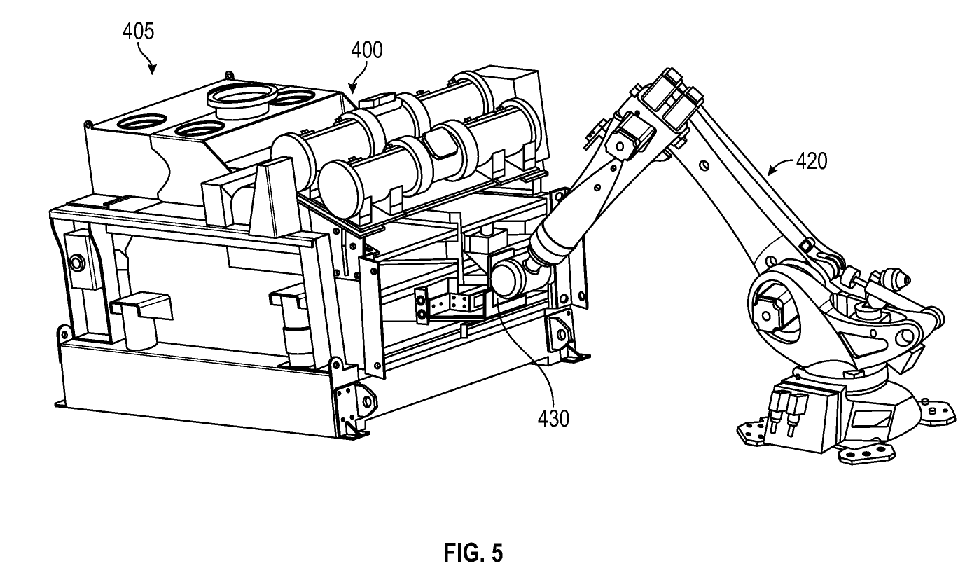

FIGS. 4 and 5 depict perspective views of pressure differential monitoring systems 305, 405, respectively, in accordance with embodiments of the present disclosure. The pressure differential monitoring system 305, 405 may comprise monitoring tools 330, 430 coupled to actuated arms 320, 420, respectively. The actuated arms 320, 420 may include articulated arms having joint(s). In some embodiments, the monitoring tools 330, 430 may be coupled to the actuated arms 320, 420 at an end 325 of the actuated arms 320, 420. As shown in FIG. 4, the monitoring tools 330, 430 may include many tools and/or devices, including, for example, a housing having the imaging device, such as, for example, a camera 335 configured to monitor the slurry, fluids and/or solids, fines or cuttings being processed within the shaker 10 or the shakers 210 and/or on the screens 18 or the screen 28 and/or exiting the discharge end 14 of the shaker 10 or the shakers 210. As a result, the camera 335 may monitor the amount of fluid on the cuttings on a screen, such as, screens 18 or screen 28 and/or the amount of fluid on the cuttings leaving the discharge end 14 of the shaker 10 or shakers 210. Moreover, the camera 335 may produce an image or video of the slurry, fluids and/or solids or cutting within the shaker 10 or shakers 210 or the fluids and cuttings leaving the discharge end 14 of the shaker 10 or shakers 210. The controller 250 and/or computer system 700 may identify and/or determine the status, quality and/or property of the fluids and fines or cuttings by comparing the image or video produced by the camera 335 with one or more known or comparative images or videos illustrating known or comparative status, quality and/or property of similar or the same fluids and cuttings. Based, at least in part, on the identified and/or determined status, quality and/or property, the controller 250 and/or the computer system 700 may automatically change one or more of the operational parameters of the PSA 24. Thus, the controller 250 and/or the computer system 700 may automatically increase or decrease an amount of one or more subsequent pressure differentials provided by the PSA 24 based on the identified and/or determined status, quality and/or property. In an embodiment, the identified and/or determined status, quality and/or property may be an amount of fluid on the cuttings.

The camera 335 may also be configured to monitor fines present in separated fluid passing through the screens 18 or the screen 28 of the shakers 10, 210, respectively. The camera 335 may produce an image or video of the fines and separated fluid passing through the screens 18 or screen 28. The controller 250 and/or computer system 700 may identify and/or determine the status, quality and/or property of the fluids and fines by comparing the image or video produced by the camera 335 with one or more known or comparative images or videos illustrating known or comparative status, quality and/or property of similar or the same fluids and/or fines. Based, at least in part, on the identified and/or determined status, quality and/or property, the controller 250 and/or the computer system 700 may automatically change one or more of the operational parameters of the PSA 24. Thus, the controller 250 and/or the computer system 700 may automatically adjust one or more screens of the shaker 10 or shakers 210 and/or may automatically increase or decrease an amount of one or more subsequent pressure differentials provided by the PSA 24 based on the identified and/or determined status, quality and/or property. In an embodiment, the identified and/or determined status, quality and/or property may be an amount of fines in the separated fluids passing through the screens 18 or screen 28.

In embodiments, the camera 335 may produce an image or video of content(s) of the collected sample taken or collected by the actuated arm 320. The controller 250 and/or computer system 700 may identify and/or determine the status, quality and/or property of the content(s) of the collected sample by comparing the image or video produced by the camera 335 with one or more known or comparative images or videos illustrating known or comparative status, quality and/or property of a similar or same content(s) of a similar or same collected sample. Based, at least in part, on the identified and/or determined status, quality and/or property of the content(s) of the collected sample, the controller 250 and/or the computer system 700 may automatically change one or more of the operational parameters of the PSA 24. Thus, the controller 250 and/or the computer system 700 may automatically increase or decrease an amount of one or more subsequent pressure differentials provided by the PSA 24 based on the identified and/or determined status, quality and/or property of the content(s) of the collected sample. In an embodiment, the identified and/or determined status, quality and/or property may be an amount of fluid on the cuttings or an amount of fines in the separated fluids passing through the screens 18 or screen 28.

While various aspects and examples have been disclosed herein, other aspects and examples will be apparent to those skilled in the art. The various aspects and examples disclosed herein are for purposes of illustration and are not intended to be limiting, with the true scope and spirit being indicated by the following claims.

What is claimed is:

1. A method, comprising:
monitoring, using a monitoring tool or actuated arm coupled to the monitoring tool, fluid containing one or more solids located adjacent to a discharge end of a shaker for separating the one or more solids from the fluid;
determining at least one property selected from at least one fluid property and at least one solids property, wherein the at least one fluid property comprises an amount of the fluid on the one or more solids and the at least one solids property comprises an amount of the one or more solids present in the fluid; and
controlling, via a controller, a pressure differential system adjust to a screen in the shaker based at least in part on the determined at least one property, wherein the controller is in electrical communication with the actuated arm, the monitoring tool, and the pressure differential system.

2. The method according to claim 1, wherein controlling the pressure differential system includes:
changing application of at least one pressure differential by the pressure differential system at or near the screen in the shaker.

3. The method according to claim 2, wherein changing application of the at least one pressure differential includes:
increasing an amount of pressure differential applied by the pressure differential system at or near a bottom side of the screen in the shaker; or
decreasing the amount of pressure differential applied by the pressure differential system at or near a bottom side of the screen in the shaker.

4. The method according to claim 1, wherein controlling the pressure differential system includes:
changing at least one operational parameter of at least one pressure differential applied by the pressure differential system at or near the screen in the shaker, wherein the at least one operational parameter comprises frequency, intensity and duration of the at least one pressure differential.

5. The method according to claim 1, wherein controlling the pressure differential system occurs without intervention of a human operator.

6. The method according to claim 1, wherein monitoring the fluid containing the one or more solids collecting includes one selected from:
monitoring the fluid and the one or more solids located on the screen in the shaker;
monitoring the fluid and the one or more solids leaving the screen in the shaker; and
monitoring the fluid and the one or more solids passing through the screen in the shaker.

7. The method according to claim 6, wherein the screen is located at the discharge end of the shaker.

8. The method according to claim 6, wherein monitoring the fluid and the one or more solids includes:
producing, using an imaging device or tool, at least one image or video of the fluid and the one or more solids; or
collecting, using a collection tool or tray, a sample of the fluid and the one or more solids.

9. The method according to claim 8, wherein determining at least one property includes:
comparing the produced at least one image or video to at least one comparative image or video of at least one same or similar fluid and at least one same or similar solid; or
determining at least one amount selected from an amount of the fluid on the one or more solids in the collected sample and an amount of fines present in the fluid in the collected sample.

10. A system, comprising:
a pressure differential system adjacent a screen in a shaker for separating one or more solids from a fluid, the pressure differential system adapted to provide a pressure differential adjacent the screen in the shaker;
a monitoring tool coupled to an actuated arm adjacent the shaker, the monitoring tool adapted to monitor the one or more solids and the fluid adjacent the screen in the shaker; and
a controller in electrical communication with the pressure differential system, the monitoring tool and the actuated arm, wherein the controller is adapted to control the pressure differential based on the monitoring of the one or more solids and the fluid adjacent the screen of the shaker.

11. The system according to claim 10, further comprising:
an imaging device or tool of the monitoring tool adapted to produce at least one image or video of the one or more solids and the fluid adjacent the screen of the shaker

12. The system according to claim 11, further comprising:
one or more comparative images or videos of same or similar solids and same or similar fluids, wherein the controller is adapted to compare the produced at least one image or video to the one or more comparative images or videos.

13. The system according to claim 10, further comprising:
a collection tool or tray coupled to the actuated arm adapted to collect a sample of the one or more solids and the fluid adjacent the screen of the shaker.

14. The system according to claim 13, further comprising:
an analyzer in electrical communication with the controller, wherein the analyzer is adapted to determine at least one amount selected from an amount of the fluid on the one or more solids in the collected sample and an amount of fines in the fluid in the collected sample.

15. The system according to claim 10, wherein the controller is adapted to control the pressure differential system based on an amount of the fluid on the one or more solids or an amount of fines present in the liquid.

16. A system, comprising:
a controller adapted to a control pressure differential system adjacent a screen in a shaker for separating solids from a fluid; and
an imaging device operatively, coupled to an actuated arm, adjacent to the screen in the shaker, wherein the imaging device, the actuated arm and the pressure differential system are in electrical communication with the controller, wherein the imaging device is adapted to produce at least one image of the solids and fluid adjacent to the screen and transmit the produced at least one image to the controller,
wherein the controller automatically controls the pressure differential system based, at least in part, on the produced at least one image.

17. The system according to claim 16, further comprising:
a collection tool or tray coupled to the actuated arm, wherein the collection tool or tray is adapted to collect a sample of the solids and the fluid adjacent to the screen.

18. The system according to claim 17, further comprising:
an analyzer in electrical communication with the controller, the analyzer adapted to determine a property associated with the collected sample and transmit data representative of the determined property to the controller,
wherein the controller controls the pressure differential system based on the determined property.

19. The system according to claim 16, wherein the screen is located at the discharge end of the shaker and the determined property is at least one amount selected from an amount of the liquid on the solids in the collected sample and an amount of fines present in the liquid in the collected sample.

20. The system according to claim 16, wherein at least the controller is, or at least a part of, an autonomous machine.
